(19) United States
(12) Patent Application Publication
(10) Pub. No.: US 2024/0302826 A1
(43) Pub. Date: Sep. 12, 2024

(54) VEHICLE SERVICE APPARATUS AND METHOD FOR PERFORMING A VEHICLE SERVICE

(71) Applicant: NEXION S.P.A., CORREGGIO (REGGIO EMILIA) (IT)

(72) Inventor: GIULIO CORGHI, CORREGGIO (REGGIO EMILIA) (IT)

(21) Appl. No.: 18/578,220

(22) PCT Filed: Jul. 14, 2022
(86) PCT No.: PCT/IB2022/056494

§ 371 Date: Jan. 10, 2024

(30) Foreign Application Priority Data
Jul. 15, 2021 (IT) 102021000018683

(51) Int. Cl. G05B 19/418; B60S 5/00

(52) U.S. Cl. CPC G05B 19/41865; B60S 5/00; G05B 2219/42337

(57) ABSTRACT

A vehicle service apparatus, for a wheeled vehicle operatively positioned in a workspace of a workshop, includes a service structure including at least one displaceable component configured to be displaced relative to the vehicle or be removably connected to the vehicle and a real time locating system. This system includes a plurality of emitters configured to emit a succession of electromagnetic signals and one or more receivers, operatively connected to the at least one displaceable component and configured to receive electromagnetic signals emitted by the plurality of emitters. The locating system is configured to derive a position of one or more receivers in real time, thus determining the position of the displaceable component. The apparatus includes a processing unit, connected to the locating system to receive a location signal representing the position of the displaceable component and programmed to generate service information for a user, based on the location signal.

### TECHNICAL FIELD

This invention relates to a vehicle service apparatus and to a method for performing a vehicle service.

### BACKGROUND ART

Such a service apparatus can be widely used in operations for measuring and adjusting vehicle alignment and/or setting up a calibration system for the sensors of an advanced driver assistance system (ADAS) of the vehicle.

In effect, in such operations, it is especially important that components of the vehicle and/or components of structures useful for calibrating vehicle sensors and for vehicle alignment be located in real time.

To date, vehicle alignment (for example, wheel camber and toe) can be checked using an apparatus comprising a plurality of cameras configured to successively capture image data relating to the vehicle wheels and/or to targets applied to the wheel.

More in detail, as disclosed, for example, in EP3629053A1 (a document in the name of the present Applicant), the apparatus comprises movable carriages or trolleys (mounted on wheels or tracks) that run along directions parallel to the longitudinal axis of the vehicle. Normally, there is one carriage moving along each side of the vehicle. Located on these carriages are measuring units on which there are mounted a plurality of cameras (usually two) directed towards the vehicle wheels and configured to capture image data relating to each wheel.

Alternatively, the cameras may be mounted on a supporting structure at an elevated height relative to the vehicle, as disclosed for example, in application IT202000017578 (a document in the name of the present Applicant), and a carriage is movable along the supporting structure.

In this situation, each camera is calibrated relative to a local reference system but the image data captured must be referenced to a spatial reference system common to all the cameras.

For the image data to be referenced to a single spatial reference system, a structure provided with two targets (or panels) is placed at a position in front of the vehicle so it can be framed by a further camera, called field camera, also mounted on the measuring unit, at a predefined position relative to the other cameras. Since the two targets are fixed, all the cameras of the carriages are referenced to a single reference system by processing the image data captured by them and the data deriving from the field cameras.

It is also necessary for a service apparatus used to calibrate the sensors of the vehicle's advanced driver assistance system (ADAS) to be positioned correctly (that is, according to the specifications of the vehicle manufacturer).

To date, this operation has been carried out using movable apparatuses that can be placed at a specified position relative to the vehicle whose sensors need to be calibrated.

As is known, to position the apparatuses suitably relative to the vehicle, the apparatuses are provided with distance meters, cameras or similar instruments configured to interact with each other in order to capture distance and/or image data of the structure relative to the vehicle itself (or relative to targets mounted thereon) and to provide an operator with instructions for moving the structure to the correct position.

An example of an apparatus of this kind is described in EP3686551A1 (a document in the name of the present Applicant).

Patent document U.S. Pat. No. 5,140,533 regards a machine for servicing a vehicle and discloses a real time location system. However, such a location system does not have the desired accuracy and effectiveness.

Disadvantageously, prior art vehicle service apparatuses are particularly complex to install, use and position.

Moreover, these apparatuses are particularly expensive because they are made up of a large number of components that interact with each other.

Another disadvantage is due to the complexity of the setups of prior art vehicle assistance systems which makes mounting, setting up and then activating the apparatus a particularly laborious and time-consuming task.

This disclosure has for an aim to provide a vehicle service apparatus and a method for performing a vehicle service to overcome the abovementioned disadvantages of the prior art.

### DISCLOSURE OF THE INVENTION

The aim of this invention, therefore, is to provide a vehicle service apparatus that is at once reliable and easy to use.

Another aim of this invention is to provide a vehicle service apparatus that is quick and easy to set up.

The technical purpose indicated and the aims specified are substantially achieved by a vehicle service apparatus and a method for performing a vehicle service comprising the technical features described in one or more of the appended claims. The dependent claims correspond to possible embodiments of the invention.

In particular, the aims specified are achieved by a vehicle service apparatus and, more specifically, for a rubber tyred vehicle operatively positioned in a workspace of a repair shop. The apparatus comprises a service structure disposed in the workspace and including at least one displaceable component configured to be displaced relative to the vehicle or to be removably connected to the vehicle.

The apparatus also comprises a real time locating system (RTLS) including a plurality of emitters, each disposed at a predetermined, fixed position inside the workspace.

According to an aspect of this disclosure, the plurality of emitters are located at an elevated position overlooking the workspace.

Each emitter is configured to emit a succession of electromagnetic signals. By way of non-limiting example, these electromagnetic signals may be luminous signals, radio signals, infrared signals and the like.

The electromagnetic signals emitted are intercepted by one or more receivers placed in the workspace so that the locating system can determine a position of the receivers and of the components associated therewith. This aspect will be described in more detail and will become clearer as this description continues.

In a possible embodiment, the locating system comprises emitters according to what is described in US20190079191A1, where the emitters each comprise at least one optic generator configured to emit a light beam.

In US20190079191A1, the emitter also comprises at least one MEMS scanning mirror disposed on an optic path of the light beam and configured to reflect the light beam emitted. The MEMS scanning mirror is pivotable about at least one pivoting axis so that the light beam reflected by it is moved in the workspace and defines a receiving plane. The MEMS scanning mirror may have a single pivoting axis or, alternatively, two or more pivoting axes.

As shown in US20190079191A1, each emitter might comprise two MEMS scanning mirrors pivoting about axes that are inclined (specifically transverse) to each other and a beam divider configured to intercept the light beam emitted by the optic generator and to “divide” the beam into at least a first secondary light beam and a second secondary light beam. In this situation, the MEMS scanning mirrors are located along the trajectory of a respective secondary light beam in order to intercept it. By so doing, each secondary light beam is reflected by a respective MEMS scanning mirror and, thanks to the pivoting of the MEMS scanning mirror, is moved in the workspace to define a receiving plane. In the case of two MEMS scanning mirrors, the receiving planes defined by the secondary light beams are substantially transverse to each other, specifically perpendicular.

In a further possible embodiment (illustrated), each of the emitters comprises at least one optic generator which rotates about its axis of rotation and is configured to emit a planar light beam defining a receiving plane and, in particular, a rotating receiving plane.

Preferably, in this embodiment, each emitter comprises a first and a second optic generator having a first and a second axis of rotation which are inclined to each other, for example, at right angles.

In the embodiment illustrated, each emitter also comprises an intermittent light source adapted to define a timer for the locating system.

According to an aspect of this disclosure, the locating system also comprises one or more receivers which are operatively connected to the at least one displaceable component and which are configured to receive signals emitted by the plurality of emitters. In at least one example embodiment, the locating system comprises at least two receivers, that is to say, it comprises a plurality of receivers.

According to an aspect of this disclosure, each receiver includes a body and a plurality of sensors associated with the body and distributed at predetermined positions, mutually spaced.

In a possible embodiment, the sensors are photosensors so they can receive the light beams emitted by the optic generators of the emitters.

In another embodiment, the sensors are configured to receive the radio waves emitted by the emitters.

Alternatively, the sensors may be of a type capable of receiving infrared signals emitted by the emitters.

More generally speaking, the sensors are chosen based on the type of signals to be received, that is to say, based on the type of electromagnetic signals emitted by the emitters.

The locating system is configured to derive a position of the one or more receivers in real time based on the processing of a time interval between a first and a second electromagnetic signal sent to the receiver by at least one of the emitters. The locating system is configured to derive in real time the time interval between the first and the second electromagnetic signal sent to the receiver by the same emitter. The receiver is synchronized with the emitters, so that the processor of the receiver, upon receiving a signal, correlates the signal to one of the emitters (i.e. to the emitter that generated the signal).

In use, after positioning the emitters inside the workspace and after positioning a receiver on the displaceable component of the service structure to be located, the emitters and the sensors of the receiver are synchronized. The synchronization allows the real-time locating system to distinguish and recognize one emitter from the others emitter of the plurality of emitters. For example, the synchronization sets, for each time interval defined by a clock (wherein the emitters and the receiver include synchronized clocks), a slot to each emitter; for example, if there are three emitters, the time interval is divided in three slots, wherein the first slot is assigned to the first emitter and so on, so that each emitter emits signal only during the corresponding slot of the time interval. According to another example, it is envisaged that the signal emitted by the emitters include reference codes or coding, wherein the receiver knoes such coding and thus is able to know, once it receives a signal, what emitter has emitted that signal (for example the information about the coding of the signal is shared with the receiver during the synchronization).

Next, the emitters emit a series of electromagnetic signals (such as, for example, luminous waves, radio waves and the like), which are intercepted by the receiver sensors at different instants in time.

By measuring the time that elapses between the instants the receiver intercepts a first and second signal and since the position of the sensors of the receiver relative to each other is predetermined, the locating system is able to derive in real time the position of the receiver, hence of the displaceable component associated therewith.

By “deriving the position of the displaceable component” is meant determining the position of the displaceable component and determining its spatial orientation.

Regarding the location system and the implementation of the emitters, the receiver, and the communication therebetween, we observe that possible examples are provided in the patent documents U.S. Pat. Nos. 10,649,066, 10,146,047B1, EP3454106A1, US2019/0079191 and U.S. Pat. No. 10,530,972, which are herewith incorporated by reference as a source of example of the implementation of the real time location system.

The apparatus also comprises a processing unit connected to the locating system to receive from the locating system a location signal representing the position (and, if necessary, the orientation) of the displaceable component.

This location signal may be processed together with other location signals received from the processing unit and/or together with data stored in the processing unit itself in order to derive the position and the spatial orientation of the displaceable component relative to the workspace, relative to the vehicle (or possibly only of one or more of the parts thereof) or relative to another component of the service structure, as described in detail below.

The processing unit is also programmed to generate service information for a user, based on the location signal, such as, for example, the direction to be given to the service structure when it is used to calibrate advanced driver assistance sensors (ADAS) of the vehicle and/or information regarding the characteristic angles (such as toe and/or camber) of the wheels when it is used to check the alignment of the vehicle.

In a possible embodiment, each receiver has a built-in control unit capable of calculating its position and orientation, that is to say, capable of deriving its location signal.

More in detail, each control unit is programmed to store location information representing the position of each sensor on the body of the receiver and to process this information with the measuring data relating to the interval between the time each sensor receives at least a first electromagnetic signal and a second electromagnetic signal.

By processing the information stored in it and the data captured, the control unit is able to derive data relating to the position and orientation of the receiver inside the workspace.

In this embodiment, the control unit of each receiver then transmits the location signals representing the position (and orientation) of the respective receiver to the processing unit. The processing unit receives the location signals from the control unit and combines them to obtain the service information.

More specifically, as described above, the processing unit derives information regarding vehicle wheel alignment, real time information regarding the position of different components of the service structure relative to the vehicle (or parts thereof), real time information regarding the position of a displaceable component of the service structure relative to an additional displaceable component and the like.

During locating operations, it might be necessary to simultaneously detect the position of more than one displaceable component relative to the vehicle (or parts thereof) and/or relative to an additional displaceable component.

By way of non-limiting example, it might be necessary to derive the position of a calibration carriage (that is to say, a carriage normally used to calibrate ADAS sensors of the vehicle) relative to one of the vehicle's wheels and the position of an additional carriage, for example, a carriage provided with the vehicle's radar calibration devices, relative to a logo at the back of the vehicle. To perform location, a receiver is placed on each carriage, a receiver is placed on the vehicle, for example, on a wheel, on the logo at the front, at a front camera, on the logo at the back or on the bumper.

In this situation, the risk is that during the processing of the location signals by the processing unit, the position of the calibration carriage might be erroneously derived relative to one or more reference points of the vehicle.

To avoid this problem, each receiver is provided with an identification code which is stored in the processing unit so that when it receives the location signals from the receivers (or from their control units), the control unit can identify which receiver each comes from and can correctly determine which other location signal (from another receiver) it must be processed with.

By so doing, therefore, the processing unit can process the signal from the receiver of the vehicle (for example, at the wheel or rear logo) with the one from the receiver on the calibration carriage. In this situation, thanks to the identification codes, the processing unit can provide information regarding the mutual position of the calibration carriage and/or of the additional carriage relative to at least one wheel (for example, relative to the two rear wheels when positioning relative to the thrust axis of the vehicle is performed) and/or the vehicle's other reference points (for example, the rear logo) without the risk of mixing up the position data and obtaining incorrect data that is of no use.

With reference now to the embodiment shown in the accompanying drawings (where the emitters comprise two rotary light beam generators), when the apparatus is in use, the optic generators of the emitters each emits its own light beam so as to define, through the light beam itself, a respective rotating receiving plane. In this situation, during its rotational movement, each time a receiving plane intercepts a receiver placed in the workspace, the latter's sensors detect the light beam. By so doing, the locating system is, for each receiver, able to process the time between at least a first and a second light beam intercepted by the sensors of the receivers, and to derive the position of the receiver, hence of the displaceable component associated therewith, in real time.

In this situation, the processing unit receives from the locating system the location signal deriving from the receiver placed in the workspace and, based on that location signal, generates service information for a user.

According to an aspect of this disclosure, the service structure includes at least one displaceable component.

In an embodiment, the displaceable component is fixed to a carriage that is slidably movable on a supporting surface inside the workspace to be displaced relative to the vehicle placed in the workspace. In another embodiment, the displaceable component is fixed to a stirrup which can be removably associated with a wheel of the vehicle in a predetermined spatial relationship with the wheel itself.

In another possible embodiment, the displaceable component can be fixed to a predetermined point of the vehicle, for example, at the rear logo or the front logo or a camera of the vehicle.

In another embodiment, the displaceable component can be fixed to a reflecting element, typically prism shaped, or a Doppler signal simulator positioned on a trestle-like supporting element.

In another possible embodiment, the displaceable component is applied to a belt provided with a graphical pattern and located at a predetermined position relative to the longitudinal axis of the vehicle and, in particular, at a position where it is parallel to that axis.

In a possible embodiment, the service structure comprises a plurality of stirrups, each operatively connected to a respective wheel of the vehicle in a predetermined spatial relationship with the wheel itself. In this embodiment, the locating system includes a corresponding plurality of receivers, each connected to a respective stirrup of the plurality of stirrups.

By so doing, during locating operations, the receivers intercept the signals emitted by the emitters so that the stirrups the receivers are connected to, hence the vehicle wheels as well, can be located by processing the time interval between at least a first and a second electromagnetic signal sent by at least one (preferably at least two) of the emitters to the receivers. In this situation, the processing unit is programmed to derive, from the location signals received from the locating system, characteristic angles of the vehicle wheels such as, for example, toe and/or camber.

In other words, by positioning the receivers on the vehicle wheels and processing the data relating to their position in real time, it is possible to obtain information regarding the alignment of the vehicle.

In another embodiment, the service structure includes a carriage that is movable so it can be displaced relative to the vehicle placed in the workspace.

The carriage may be movable slidably along a raised supporting assembly of the type shown in IT102020000017578. This supporting assembly comprises a horizontal beam on which the carriage runs and two vertical uprights configured to support the beam at a predetermined height from the ground.

Alternatively, the carriage may be slidably movable (for example, on wheels or rails) on a supporting surface inside the workspace to be displaced relative to the vehicle placed in the workspace.

According to an aspect of this disclosure, the service structure comprises a measuring unit that is integral with the carriage. The measuring unit comprises a supporting body on which an optical measuring device, such as a pair of cameras in a stereo configuration or a LIDAR (laser imaging detection and ranging) remote detector is mounted. The optical measuring device is configured to capture image data of a vehicle wheel.

The carriage is also provided with at least one receiver. More precisely, the receiver is located on the above mentioned supporting body at a known position, stored in the processing unit of the apparatus, relative to the optical measuring device.

The service structure may comprise any number of carriages.

For example, the service structure may comprise a carriage for each wheel of the vehicle. In this situation, the carriages are stationary at a position facing a respective wheel so that the optical measuring device is directed at the wheel.

In another example, the service structure includes two carriages, each provided with a respective measuring unit and a respective receiver. Each carriage can run alongside the vehicle in a direction parallel to the longitudinal axis of the vehicle and is positioned first at a position facing a respective front wheel of the vehicle and secondly at a position facing a respective rear wheel of the vehicle.

Alternatively, the service structure may include—for example, in the case of a lorry (or a generic vehicle having different axles)—two or more carriages running along each side of the lorry.

The carriages may run on tracks or they may be mounted on wheels.

The carriages may be moved manually or by automated means.

In use, the carriages are positioned at a position facing a respective wheel so that the optical measuring device is directed towards the wheel.

If the service structure comprises a carriage for each of the vehicle wheels, the carriages, once positioned, remain stationary.

On the other hand, if the structure comprises less carriages than there are wheels, the carriages are first placed in proximity to a respective front wheel of the vehicle and then, after the operations for locating that wheel, they are moved towards a rear wheel, where the locating operations are repeated.

Once the carriages have been positioned near the respective vehicle wheels, the optical measuring device captures image data relating to the wheel, while the receiver intercepts the signals emitted by the emitters.

In this situation, the processing unit is programmed to derive, from the location signals received from the locating system and from the image data captured by the optical measuring device, characteristic angles of the vehicle wheels such as, for example, toe and/or camber.

More in detail, the processing unit receives from each receiver a location signal indicating the position of that receiver, hence of the carriage associated therewith, inside the workspace.

At the same time, the processing unit receives from the optical device representing the position of each wheel relative to the optical measuring device itself.

In this situation, the processing unit is able to provide the user with information relating to vehicle alignment by processing the signals from the receivers and the image data from the optical measuring devices with the data stored in the processing unit itself.

In other words, since the relative position between each receiver and the respective optical measuring device mounted on the same carriage is known (because it is stored in the processing unit), by capturing (with the optical measuring device) the position of each receiver in the workspace and capturing (with the optical measuring device) the position of each wheel relative to the optical measuring device, it is possible to derive the position (and the orientation) of a wheel relative to all the others and thus, it is possible to obtain information regarding the alignment of the vehicle as a whole.

In another possible embodiment, the service structure includes a carriage that is slidably movable on a supporting surface inside the workspace to be displaced relative to the vehicle placed in the workspace.

The service structure also comprises a vehicle calibration assistance structure mounted on the carriage. The calibration assistance structure includes a calibration device, configured to facilitate alignment or calibration of a sensor of an advanced driver assistance system (ADAS) of the vehicle. The calibration device is located on the carriage at a predetermined position, specified by the manufacturer of the vehicle whose ADAS sensors are to be calibrated.

To calibrate the sensors correctly, it is important for the calibration device to be detected by the ADAS sensor when the device is located, relative to the vehicle, at a position specified by the vehicle manufacturer. In this situation, therefore, it is important for the carriage to be drivable in the workspace so as to be able to contribute to correctly positioning the calibration device mounted thereon.

To determine whether the carriage, hence the calibration device associated therewith, is correctly positioned relative to the vehicle, at least one of the detectors is mounted on the carriage in such a way that the latter can be located in the workspace.

Preferably, a detector is also mounted on each wheel, for example, by means of a stirrup, in a predetermined spatial relationship with the wheel. During locating operations, the receivers intercept the signals emitted by the emitters so that the carriage and the vehicle wheels can be located in the workspace by processing the time interval between at least a first and a second electromagnetic signal sent by at least one of the emitters to the receivers.

In this situation, the processing unit is programmed to receive from the locating system the location signals of the receivers and to process these signals in real time to derive a position of the carriage, hence of the calibration device, relative to the vehicle.

In other words, the locating system determines the position, inside the workspace, of the displaceable components which the receivers are mounted on (specifically, the receivers of the carriage and the vehicle wheels) and sends the related location signals to the processing unit. The processing unit receives the location signals and processes them with each other in order to determine the position of the carriage relative to the vehicle wheels and, where necessary, the position of the calibration device relative to the vehicle. In this situation, the processing unit is also programmed to provide information for positioning the carriage relative to the vehicle.

More specifically, this information is provided in the form of instructions for the user to move the carriage. That way, the user is directed by the processing unit to move the carriage in such a way that the calibration device reaches the predetermined position.

In other words, using the processing unit to process the data generated by the locating system, it is possible to determine the position of the carriage relative to the vehicle (specifically, relative to the wheels) in real time. In this situation, it is thus possible to determine by how much the current position of the calibration device deviates from the predetermined position and to move the carriage accordingly.

Advantageously, the apparatus of the disclosure allows quickly and reliably locating one or more displaceable components of the driver service system relative to the vehicle, making vehicle alignment checking and sensor calibration operations more precise, easier and quicker.

In another possible embodiment, the displaceable component may be a trestle-like supporting element on which the calibration device—for example, a reflecting prism or a Doppler signal simulator—is mounted at a predetermined positioned specified by the vehicle manufacturer. Also in this embodiment, a detector is mounted on each wheel of the vehicle, or alternatively on another point on the vehicle (for example, in proximity to the vehicle's rear logo) in a predetermined spatial relationship with the vehicle. In this situation, the carriage locating operations described above are performed to locate the trestle-like supporting element in such a way as to place the calibration device at the position specified by the vehicle manufacturer.

Also an object of this disclosure is a method for performing a service on a vehicle provided with rubber tyred wheels and positioned in a workspace.

The method comprises a step of preparing a service structure positioned in the workspace and including at least one displaceable component configured to be displaced relative to the vehicle or to be removably connected to the vehicle.

The method also comprises a step of preparing a real time locating system (RTLS) including one or more receivers configured to receive electromagnetic signals.

The receivers each include a body and a plurality of sensors associated with the body and distributed at predetermined positions, mutually spaced.

The locating system also includes a plurality of emitters, each disposed at a predetermined, fixed position in the workspace and configured to emit a succession of electromagnetic signals. The electromagnetic signals are received by the sensors of the receivers in order to be able to locate the receivers, as described in detail below.

The method also comprises a step of positioning the at least one displaceable component in the workspace, spaced from the vehicle or connected to the vehicle and a step of connecting one or more receivers to the at least one displaceable component.

In an embodiment of this disclosure, the method comprises a step of temporally synchronizing the emitters.

The method then comprises a step of deriving the position of the at least one receiver in real time through the locating system, based on processing a time interval between at least a first and a second electromagnetic signal emitted by at least one of the emitters so as to generate a location signal representing the position (and, if necessary, the orientation) of the displaceable component.

The method then comprises a step of generating service information for a user, through a processing unit and based on the location signal.

In a possible embodiment, each receiver comprises a control unit configured to generate a location signal representing the position of the receiver (hence of the displaceable component associated therewith) in the workspace. In this situation, the method comprises a step of each control unit sending the location signal to the processing unit. The processing unit receives and processes the location signals to determine service information such as, for example, the position of the displaceable component relative to the vehicle and/or relative to a part thereof or relative to a further displaceable component of the service structure.

According to an aspect of this disclosure, the service structure comprises a plurality of stirrups, each defining a displaceable component and removably connected to a respective wheel of the vehicle in a predetermined spatial relationship with the wheel itself. The service structure also comprises a corresponding plurality of receivers. Each receiver is coupled to a respective stirrup of the plurality of stirrups so that when the locating system is activated, the position of each vehicle wheel can be determined in real time.

The method then comprises a step of processing with the processing unit the location signals deriving from the locating system. During this step, the processing unit derives the position of each wheel relative to the other wheels and identifies the characteristic angles of the vehicle wheels so that their alignment can be assessed.

Alternatively, the service structure comprises a carriage that is slidably movable on a supporting surface inside the workspace. In this situation, the carriage acts as displaceable component and one of the detectors is connected to it.

More in detail, the carriage comprises a measuring unit provided with a supporting body, on which the receiver is mounted and on which an optical measuring device configured to capture image data of a vehicle wheel is also mounted at a predetermined position relative to the receiver.

Preferably, the relative position of the receiver relative to the optical measuring device is stored in the processing unit.

In this situation, the method comprises a step of adjusting the relative position of the carriage relative to the vehicle so that the optical measuring device can “see” a wheel of the vehicle.

After this step, the position of each wheel of the vehicle inside the workspace is derived by the locating system, which sends the signals representing these positions to the processing unit.

At the same time, the optical measuring device captures image data of the wheel facing it and from which is derived information regarding the position of that wheel relative to the optical measuring device itself.

In this situation, the method comprises a step of processing with the processing unit the location signals received from the locating system and the image data captured by the optical measuring device in order to derive characteristic alignment angles of the vehicle wheels.

More in detail, in the step of processing, the processing unit derives from the location signals the position of each wheel in the workspace. In the step of processing, the processing unit also derives, in this case from the image data, the position of each wheel relative to the optical measuring device it is facing.

Also during the step of processing, the processing unit combines the above mentioned derived position with the data item representing the relative position between the receiver and the optical measuring device (stored in the processing unit).

In this situation, the processing unit derives the position (and the orientation) of a wheel relative to the others, that is to say, it derives information regarding vehicle alignment as a whole.

According to a further aspect of this disclosure, the service structure includes a carriage that is slidably movable on a supporting surface inside the workspace. In this situation, at least one of the detectors is connected to the carriage so that the carriage acts as displaceable component to be located.

In a possible embodiment, each vehicle wheel is also equipped with a receiver so that its position can be derived by the locating system.

The service structure also comprises a vehicle calibration assistance structure mounted on the carriage and including a calibration device, for example, a calibration target panel, configured to facilitate alignment or calibration of a sensor of an advanced driver assistance system (ADAS) of the vehicle.

To calibrate the sensors correctly, it is important for the calibration device to occupy a predetermined position relative to the vehicle, as specified by the vehicle manufacturer. It is also important for the calibration device to be mounted on the carriage according to the specifications of the vehicle manufacturer.

The method thus comprises a step of mounting the calibration device on the carriage at a position specified by the manufacturer.

In this situation, once the device is mounted on the carriage, it is located relative to the vehicle, thus deriving the real time position of the calibration device, hence its distance from the specified position.

The real time position of the vehicle wheels is also derived and sent to the processing unit.

In this situation, the method comprises a step of processing the location signals deriving from the receivers in real time through the processing unit in order to derive positioning information regarding a position of the calibration device relative to the vehicle.

In other words, the locating system allows determining the real time position of the calibration device inside the workspace. This location information is processed by the processing unit to derive a position of the calibration device relative to the vehicle (specifically, relative to the wheels the receivers are mounted on) to provide a user with information as to how (and to where) the carriage should be moved for the calibration device to adopt the specified position.

Thus, the method comprises a step of displacing the carriage relative to the vehicle so that the sensor of the vehicle can detect the calibration device. The displacement is based on the information processed by the processing unit and supplied to the user, for example, through a display located on the service structure.

In a possible embodiment, the processing unit can send directly to a control unit of the carriage the information, specifically the instructions, regarding the movement of the carriage in such a way that the carriage can, by automated means, position itself automatically according to the instructions provided by the processing unit.

By so doing, positioning the carriage relative to the vehicle is made easier, hence calibrating the vehicle sensors is more precise and reliable.

According to a further aspect of this disclosure, the displaceable component may provide a feeler for sensing the centre of a wheel. In this case, the displaceable component includes a handle and an operating head connected to the handle. For example, the handle elongates from a first end to a second end and the operating head is provided at the second end of the handle. The head is provided with a contact member, protruding in a predetermined direction, and adapted to contact the centre of the wheel. The receiver is connected to the displaceable component, preferably to the head. For example, the head has a first face and a second face opposite the first face, wherein the contact member protrudes from the first face and the receiver is connected to the second face. In one example, the contact member is provided at a free end thereof, with a plurality of fingers providing a corresponding plurality of tips, so that, when all the tips of the plurality make simultaneous contact with the surface to be contacted, the displaceable component is located in a predetermined relative position (geometrical relation) with respect to the surface to be contacted. The displaceable component may also provide a pushbutton or any other control element, so that the position sensed by the receiver (in the instant the pushbutton is activated) is memorized responsive to the activation of the pushbutton. For example, the displaceable component is configured to send a command to the control unit, upon activation of the pushbutton, wherein the control unit is programmed to memorize the position sensed by the receiver responsive to the command.

According to this example, the displaceable component is used in the following manner. The person holds the handle and manually positions the displaceable component in such a way that the contact member contacts the centre of a wheel, wherein the wheel is mounted on a car. Once contact is made, in that position (contact position), the position detected by the emitter is acquired and noted; for example, it may be saved in a memory automatically, upon pressing the pushbutton button (or any other command element) provided in the displaceable component.

Hence, the present disclosure also provides a method for detecting the position of the centre of the wheels of a car (and preferably also the orientation of the wheel axes), in a particularly easy and fact way.

According to a further aspect of this disclosure, a plurality off receiver may be associated, spaced one from the other, to targets (or reference panes) of an ADAS calibrating system. In this way, the vehicle service apparatus knows and can acquire (and memorize) in real time the position of the targets (or reference panes); this is particularly useful during the step of positioning the targets with respect to the car, but also during the performing of the ADAS calibration (so that the apparatus knows the position of the targets at the time the calibration is made). Further features and advantages of this disclosure are more apparent in the exemplary, hence non-limiting, description of an embodiment of a vehicle service apparatus and of a method for performing such a service.

### BRIEF DESCRIPTION OF DRAWINGS

The description is set out below with reference to the accompanying drawings which are provided solely for purposes of illustration without limiting the scope of the invention and in which:

FIG. 1 shows a perspective view of a vehicle service apparatus according to this disclosure;

FIG. 1A shows a detail from FIG. 1;

FIG. 2 shows a perspective view of a further embodiment of a vehicle service apparatus;

FIG. 2A shows a detail from FIG. 2;

FIG. 3A shows a perspective view of a further embodiment of a vehicle service apparatus;

FIG. 3B shows a perspective view of a possible service structure of the service apparatus;

FIG. 3C shows a perspective view of a further embodiment of a vehicle service apparatus;

FIGS. 4A and 4B show, respectively, a perspective view and a cross sectional view of a receiver and an emitter of the vehicle service apparatus.

### DETAILED DESCRIPTION OF PREFERRED EMBODIMENTS OF THE INVENTION

With reference to the accompanying drawings, the numeral 100 denotes a service apparatus for a vehicle V, specifically a vehicle provided with rubber tyred wheels R, operatively positioned in a workspace of a repair shop.

The apparatus 100 comprises a service structure 200 that is operatively disposed in the workspace and includes at least one displaceable component 20.

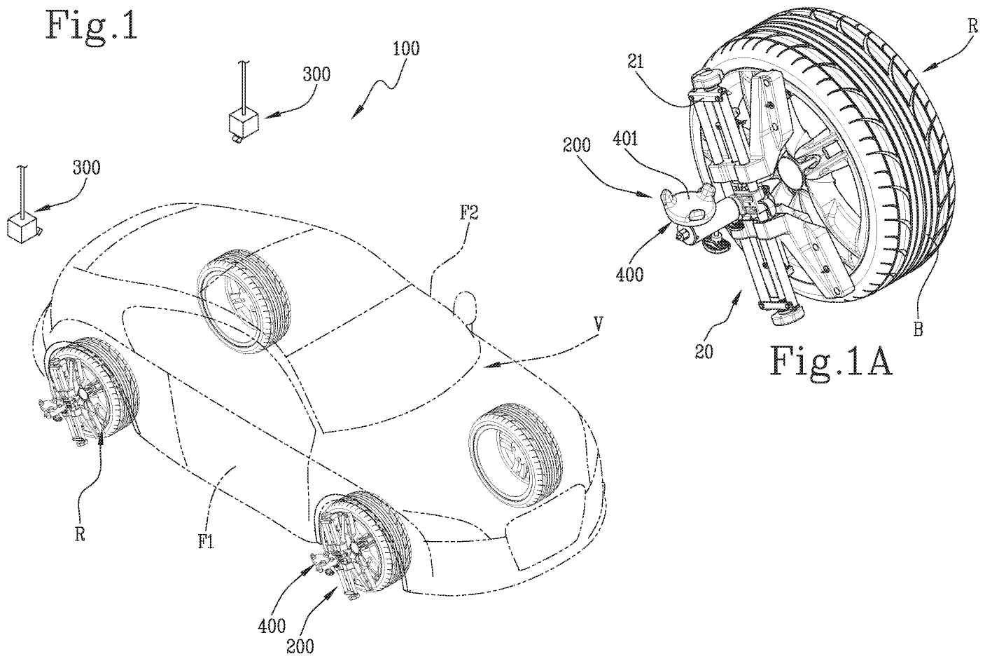

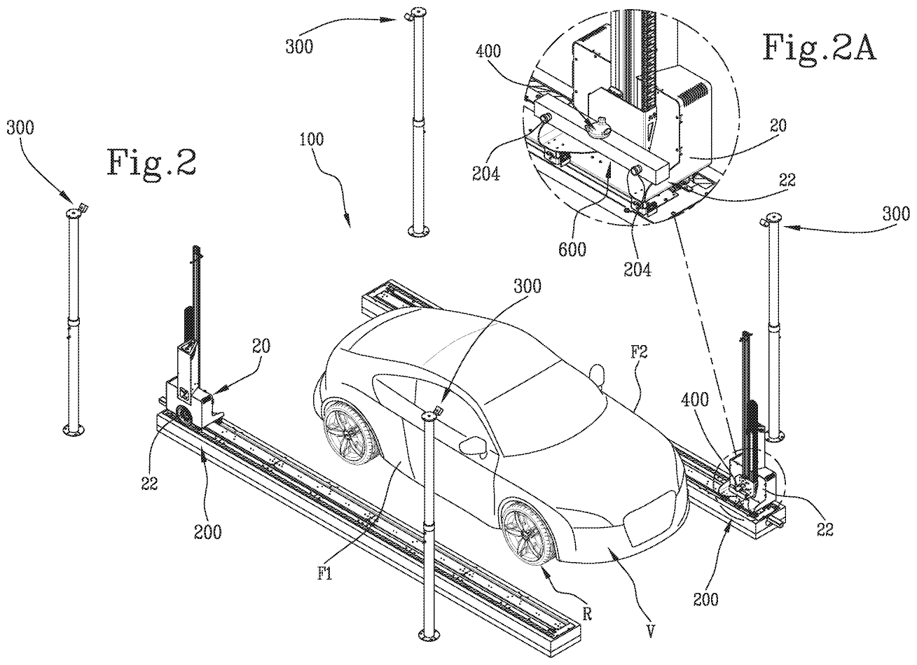

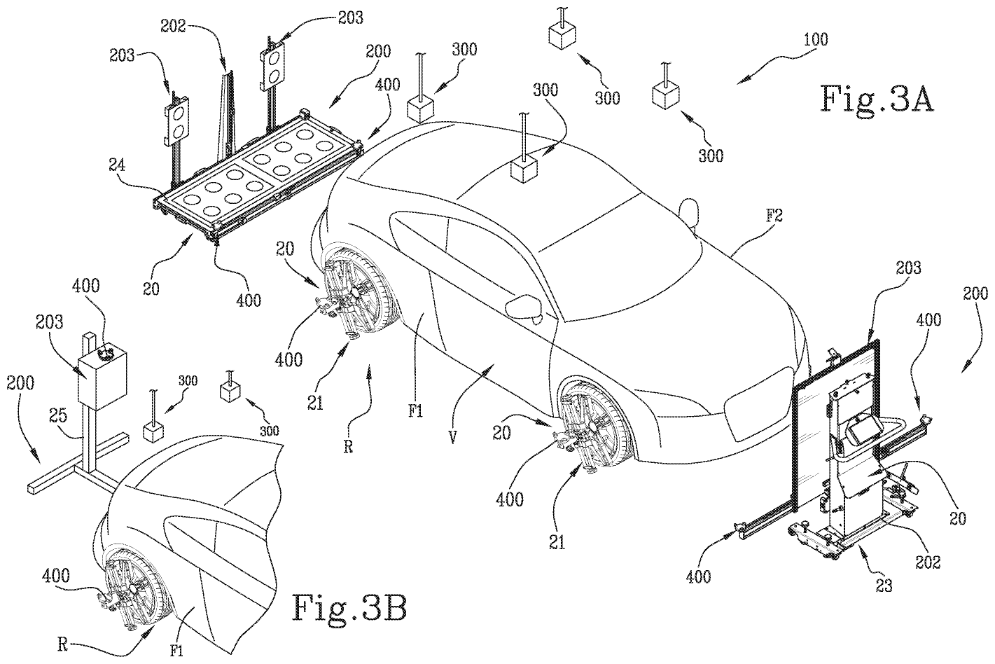

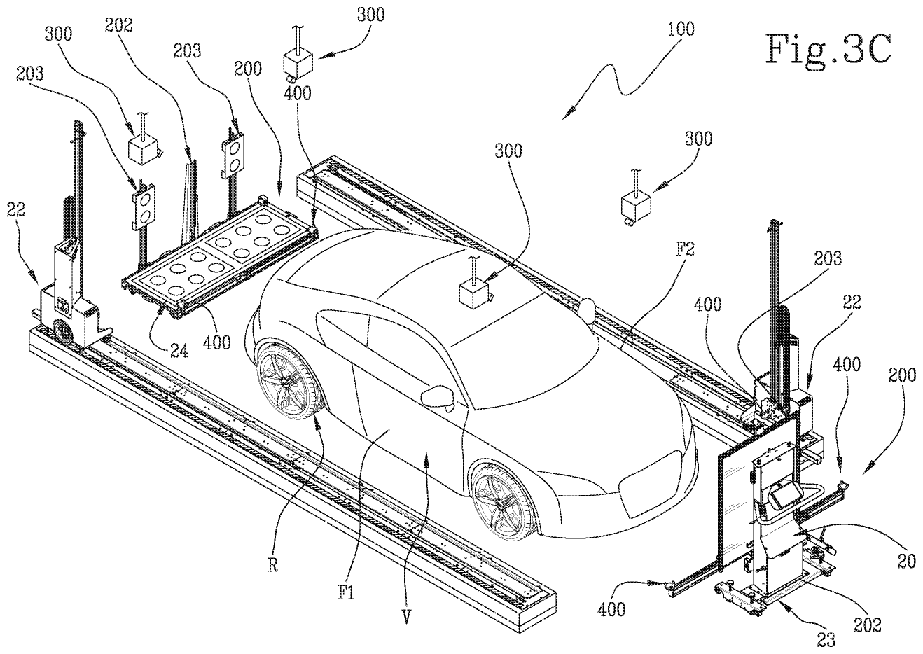

The displaceable component 20 is configured to be displaced relative to the vehicle V or to be removably connected to the vehicle V. In the example illustrated in FIG. 1 and FIG. 1A, the displaceable component 20 is a stirrup 21 and is connected to the wheel R of the vehicle V, whilst in the example of FIGS. 2 and 3A or 3C, the displaceable component 20 is a carriage 22, 23, 24 and is configured to be displaced relative to the vehicle V.

The apparatus 100 also comprises a real time locating system (RTLS) including a plurality of emitters 300.

Each emitter 300 is configured to emit a succession of electromagnetic signals.

In an embodiment, the electromagnetic signals are luminous signals (not necessarily waves perceptible by the human eye). In other embodiments, the electromagnetic signals are of a different kind, for example, they may be radio waves, microwaves or infrared signals.

Each emitter 300 is disposed at a predetermined, fixed position inside the workspace.

Looking in more detail, as also shown in the embodiments in the accompanying drawings, each emitter 300 is positioned at a raised position so it overlooks the workspace.

According to an aspect of this disclosure, the number of emitters 300 present in the locating system is variable according to requirements, as described in detail below.

In an embodiment, each emitter is made according to what is described in US20190079191A1 with reference to FIG. 2.

In this situation, each emitter comprises an optic generator and at least one MEMS scanning mirror. The optic generator is configured to emit a light beam, whilst the MEMS scanning mirror is disposed on an optical path of the light beam in order to reflect the light beam. The MEMS scanning mirror is movable pivotably in such a way that the light beam reflected on it can be oriented in the workspace. In this situation, the light beam describes an oscillating receiving plane capable of scanning (“sweeping”, “illuminating”) the workspace.

In a possible embodiment, the MEMS scanning mirror has a single pivoting axis. In other embodiments, the MEMS scanning mirror may be pivotable about two or more pivoting axes so as to orient the light beam first along one receiving plane and then along a further receiving plane.

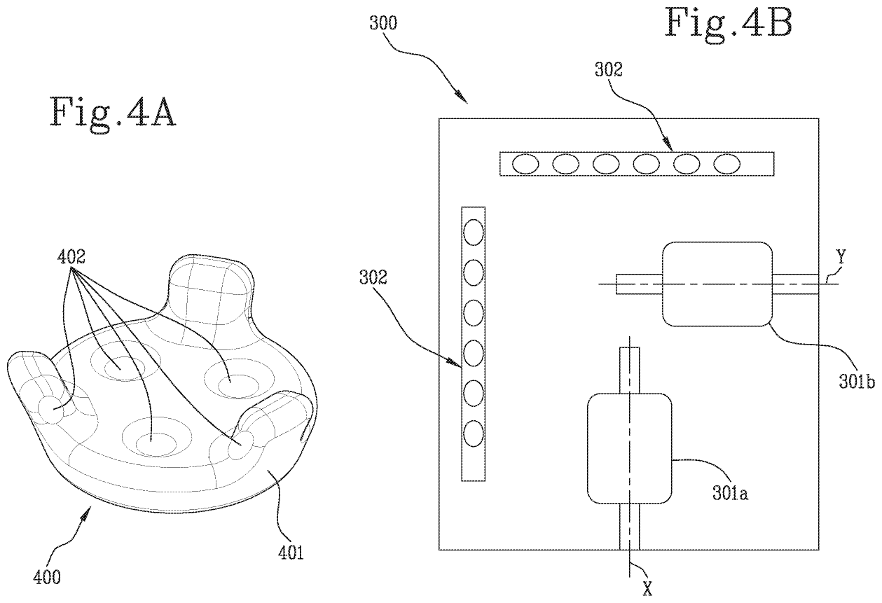

In a further embodiment, each emitter might be made according to what is described in US20190079191A1 with reference to FIG. 4.

In this situation, each emitter comprises at least one optic generator configured to emit a light beam and at least one MEMS scanning mirror movable pivotably and configured to reflect the light beam. Each emitter also comprises a beam divider and an additional MEMS scanning mirror.

In this situation, after entering the beam divider, the light beam emitted is “divided” to form a first secondary light beam and a second secondary light beam. The MEMS scanning mirror and the additional MEMS scanning mirror are disposed on the optical paths of the first secondary light beam and of the second secondary light beam, respectively, and are pivotable about different pivoting axes. In this situation, when the first secondary light beam and the second secondary light beam are reflected by the respective MEMS scanning mirrors, their optical paths describe two receiving planes which are not parallel, and are preferably perpendicular to each other. Thanks to the pivoting of the MEMS scanning mirrors, these receiving planes “sweep” the workspace in different directions. Thus, each emitter can use the first secondary light beam and the second secondary light beam at the same time to illuminate the workspace in different directions.

In the embodiment shown in FIG. 4B, on the other hand, each emitter 300 of the plurality of emitters includes at least one optic generator 301a, 301b configured to emit a planar light beam and movable in rotation about respective axes of rotation X, Y so that the planar light beam defines a rotating receiving plane.

In the embodiment illustrated, the optic generators 301a, 301b are each made in the form of a cylinder that rotates about a respective axis of rotation X, Y.

In the embodiment shown in FIG. 4B, each emitter 300 comprises a first and a second optic generator 301a, 301b that rotate, respectively, about a first and a second axis of rotation X, Y which are inclined to each other.

Preferably, the first and the second axis of rotation X, Y are perpendicular to each other, that is to say, they are substantially at right angles to each other. Alternatively, each emitter 300 might comprise any number of optic generators 301a, 301b that rotate about axes that are inclined to each other at any angle.

In the embodiment illustrated in the accompanying drawings, each emitter 300 also comprises an intermittent light source 302 adapted to define a timer for the locating system, as described in detail below.

In a possible embodiment, this light source 302 comprises at least one strip of flashing lights, for example, LEDs.

In the case illustrated by way of example in the accompanying drawings, where the emitter 300 comprises a first and a second optic generator 301a, 301b, the light source 302 comprises a first and a second light strip.

The first light strip runs parallel to the axis of rotation X of the first optic generator 301a, while the second light strip runs parallel to the axis of rotation Y of the second optic generator 301b. The first and second light strips flash in synchrony with each other.

The locating system also comprises one or more receivers 400 which are operatively connected to the at least one displaceable component 20 and which are configured to receive signals emitted by the plurality of emitters 300.

In this situation, the at least one displaceable component 20 may be located in real time by the locating system, as described in detail below.

According to an aspect of this disclosure, each receiver 400 comprises a body 401 and a plurality of sensors 402, associated therewith (FIG. 4A).

The sensors 402 are configured to receive signals emitted by the emitters 300.

In the embodiment illustrated, the sensors 402 are photosensors, that is to say, sensors capable of detecting the planar light beams emitted by the emitters 300.

Alternatively, the sensors 402 may be of any kind, based on the type of electromagnetic signals emitted by the emitters 300.

The sensors 402 are distributed at predetermined, known positions, mutually spaced on a respective receiver 400.

In use, at least one emitter 300 is installed at a raised position in the workspace.

Preferably, as illustrated in the accompanying drawings, the workspace has a plurality of emitters 300 installed in it. The positions of the emitters 300 are predetermined and known.

When a plurality of emitters 300 are installed, they are preferably suitably synchronized with each other. Preferably, the emitters 300 are synchronized each time the apparatus 100 is activated.

Next, a receiver 400 is installed on each displaceable component 20 of the service structure 200 to be located.

In the embodiments shown in the accompanying drawings, a plurality of receivers 400 are installed in the workspace, so as to be able to locate different displaceable components 20 of the service structure 200, whether they are removably connected to the vehicle V (as in FIG. 1, for example) or displaceable relative to it (as in FIGS. 2, 3A, 3B, 3C, for example).

The sensors 402 of the receivers 400 are then synchronized with each other.

In the embodiment shown in the accompanying drawings, synchronization is carried out through the light source 302 which is activated (that is, made to flash) at predetermined intervals so as to act as timer for the locating system.

After synchronization, each emitter 300 is activated in such a way as to transmit a succession of signals in the workspace.

More specifically, each emitter 300 is activated in such a way that the electromagnetic signals scan the workspace according to a precise, known frequency.

In this situation, the locating system is capable of deriving a position of each receiver 400 in real time based on the processing of a time interval between a first and a second electromagnetic signal sent to the receiver 400 by at least one of the emitters 300.

In a possible embodiment, the time interval measured is the flight time between the instant the receiver 400 intercepts a first electromagnetic signal (outbound signal) emitted by the emitter 300 and the instant the emitter 300 intercepts a second electromagnetic signal (return signal) emitted by the receiver 400 after receiving the first electromagnetic signal, according to an Ultra-wide band technology.

In the preferred embodiment, the time interval measured is, instead, the interval between the instant a first electromagnetic signal emitted by the emitter 300 is intercepted by the receiver 400 and the instant a second electromagnetic signal emitted by the same emitter 300 is intercepted. The receiver 400, upon receiving a signal, knows (e.g. thanks to a preliminary synchronization step) to what emitter the signal belongs.

In other words, once each emitter 300 has been activated, it is possible for the position (and, if necessary, the spatial orientation) of the receiver 400, hence for the displaceable component 20 of the service structure 200 associated therewith, to be derived in real time by measuring the time between a first signal intercepted by a sensor 402 of the receiver 400 and a second signal intercepted by the sensor 402, also because the position of the sensor 402 on the receiver 400 is known (since it is predetermined).

In an example, the receiver includes a plurality of sensors 402, located at a known distance (e.g. having a known geometrical relation) and the emitter emits a rotating light beam that activates the sensors 402 a in succession, wherein the receiver knows at what time instants the various sensors have been activated. Because the receiver knows (from the synchronization) that the signals (the corresponding activation of the sensors) come from the same emitter 300, the receiver 400 can derive its position, in real time. It is also observed that, in one example, the receiver 400 knows from the synchronization, for each emitter, what is the phase of the rotation of the light beam, so that the emitter 400 is able to correlate the time instant when the signal is received (i.e. the sensor is activated) to an inclination of the light beam emitted by the emitter in a spatial reference system.

In a possible embodiment, each receiver 400 may comprise a control unit that is configured to store, for each receiver 400, the mutual position of the sensors 402 and to process that data item with the data item relating to the time interval between the first and the second signal received. In this situation, each control unit is capable of deriving location information representing the position (and, if necessary, the orientation) of the receiver 400 in the workspace.

The apparatus 100 also comprises a processing unit.

The processing unit is connected to the locating system to receive a location signal representing the position of each receiver 400, hence of each displaceable component 20 associated therewith.

In a possible embodiment, the processing unit is in communication with each control unit so as to receive the signals generated by the control units.

The processing unit is also programmed to generate service information for a user, based on the location signal deriving from the locating system.

Examples of such information are: the position of the displaceable components 20 relative to the vehicle V (or a part thereof) and/or the position of the displaceable components 20 relative to one or more other components of the service structure 200. This information is useful for producing instructions regarding the direction of movement of the displaceable component 20 relative to the vehicle V, for example when having to calibrate the ADAS sensors of the vehicle V and/or information regarding the alignment of the vehicle V, as described in detail below.

Advantageously, the apparatus 100 considerably reduces the need to install complex optical systems and/or measuring systems in the workspace to define the position of one or more components of a service structure 200 inside the workspace.

Advantageously, the possibility of distributing in the workspace a plurality of receivers 400 placed on the displaceable components 20 to be located and a plurality of emitters 300 avoids having to set up complex systems and equipment for each displaceable component 20 to be located, thus reducing the costs and time needed for these operations.

To precisely derive the position of one or more components of the service structure 200 in the workspace, it is possible to install in the workspace a different combination of emitters 300 and receivers 400, according to requirements.

In effect, as shown in the accompanying drawings, the number of emitters 300 can be varied based on the configuration of the workspace and the locating operation to be performed.

In fact, it is particularly important that the sensors 402 of all the receivers 400 associated with the displaceable components 20 to be located be capable of intercepting the signals emitted by the emitters 300.

If the workspace is particularly empty, a smaller number of emitters 300 is sufficient, since all the receivers 400 distributed in the workspace will be able to intercept at least one electromagnetic signal emitted by one of the emitters 300.

Conversely, if the workspace is particularly cluttered (as a repair shop, containing cabinets, technical instruments, machinery and equipment of various kinds, very often is), it is best to install a larger number of emitters 300 so as to distribute them in the workspace in such a way that all the receivers 400 intercept one or more electromagnetic signals during locating operations.

Looking now in more detail at the embodiments shown in the accompanying drawings, FIG. 1A shows an apparatus 100 used to derive characteristic angles of the wheels R of the vehicle V such as, for example, camber and/or toe.

In this embodiment, the service structure 200 comprises at least one stirrup 21, removably associable with a wheel R of the vehicle V in a predetermined spatial relationship with the wheel R itself. The stirrup 21 acts as a displaceable component 20 of the service structure 200.

In this specification, the term “stirrup” is used to mean a device capable of being removably attached to a tyre (and more specifically, to a tyre tread B) of the wheel R of the vehicle V or, alternatively, to the bolts of the wheels R of the vehicle V, or alternatively, as in the case of the embodiment shown in FIG. 1, to the rim of the wheel R.

The stirrup 21, once applied to the wheel R of the vehicle V, is configured to support a receiver 400 in such a way that when the locating system is activated, the position of the receiver 400, hence of the wheel R it is mounted on by means of the stirrup 21, can be derived in real time.

Looking in more detail, the service structure 200 shown in FIG. 1 comprises a plurality of stirrups 21, each operatively connected to a respective wheel R of the vehicle V in a predetermined spatial relationship with the wheel R itself.

In this embodiment, the locating system also includes a first and a second emitter 300 disposed at a raised position relative to the vehicle V.

As may be seen in FIG. 1, the first emitter is located on a first side F1 of the vehicle V and the second emitter is located on a second side F2 of the vehicle V. Positioned in this way, the emitters 300 are able, with their electromagnetic signals, to reach all the receivers 400 of the locating system, preventing them from being hidden or screened by parts of the vehicle V and/or by other items present in the workspace.

If only one emitter 300 of the two shown in FIG. 1 had been positioned in the workspace—for example, the first emitter—the receivers 400 mounted on the stirrups 21 on the wheels of the second side F2 would not have been “visible” to the emitter 300 because they would have been hidden by a portion of the vehicle V. In this situation, the signals emitted by the first emitter 300 would not have been intercepted by the receivers 400, giving rise to errors in locating the receivers 400 themselves, hence in obtaining the characteristic angles of the wheels R of the vehicle V.

In use, therefore, a stirrup 21 provided with a receiver 400 is applied, in a predetermined spatial relationship, to each wheel R of the vehicle V, whilst a pair of emitters 300 is placed in the workspace at a raised position relative to the vehicle V.

The emitters 300 are started and, if necessary, synchronized with each other.

The sensors 402 of each receiver 400 are also synchronized with each other.

Once the sensors 402 have been synchronized, for each receiver 400, the time interval between the instants the receiver 400 intercepts a first and a second electromagnetic signal deriving from at least one of the emitters 300 is measured.

By measuring the time interval between the first and the second signal and since the mutual position between the sensors 402 of the same receiver 400 is known, the locating system is able to provide in real time the location signals representing the position of each receiver 400, hence of each wheel R of the vehicle V.

In this situation, the processing unit receives and combines the location signals in such a way as to derive the position and orientation of each wheel R relative to the other wheels R of the vehicle V, that is to say, in such a way as to derive information regarding the characteristic angles of the wheels R, such as, for example, toe and/or camber.

FIG. 2 shows another service apparatus 100 used to derive characteristic angles of the wheels R (or, more generally speaking, the alignment parameters of the vehicle V).

In this embodiment, the service structure 200 comprises at least one carriage 22 which constitutes the displaceable component 20 and on which at least one receiver 400 is operatively applied.

Looking in more in detail, mounted on the carriage 22 there is a measuring unit 600 on which the receiver 400 is applied.

As shown in FIG. 2A, the service structure 200 also comprises an optical measuring device 204 mounted on the carriage 22 and configured to capture image data of a wheel R of the vehicle V.

As may be seen in more detail in FIG. 2A, in this embodiment, the optical device 204 and the receiver 400 are positioned on the measuring unit 600. More specifically, the position occupied by the optical measuring device 204 relative to the receiver 400 is a predetermined, known position stored in the processing unit.

In this embodiment, the optical measuring device 204 is defined by two cameras in a stereo configuration, facing the wheel R of the vehicle V.

Alternatively, the optical measuring device 204 is a LIDAR (laser imaging detection and ranging) remote detector.

The carriage 22 may be slidably movable on a supporting surface inside the workspace to be displaced relative to the vehicle V, which is also placed in the workspace.

In the embodiment illustrated, the service structure 200 comprises two carriages 22 disposed in proximity to a respective side F1, F2 of the vehicle V so as to be movable slidably along a respective direction parallel to the longitudinal axis of the vehicle V itself.

Alternatively, the service structure 200 may comprise any number of carriages 22—for example, it may comprise one carriage 22 for each wheel R of the vehicle V.

In the example embodiment shown in FIG. 2, the locating system also includes four emitters 300 disposed at a raised position relative to the vehicle V.

Looking in more detail, with reference to FIG. 2, the emitters 300 are distributed in the workspace in such a way as to be substantially positioned at the corners of the workspace.

Positioned in this way, the emitters 300 are able, with their electromagnetic signals, to reach all the receivers 400 of the locating system, preventing them from being hidden or screened by parts of the vehicle V (for example, in the case of very high vehicles V such as goods vans) and/or by other items present in the workspace.

In use, at least one receiver 400 and one optical measuring device 204 are positioned on each carriage 22 of the service structure 200.

The carriages 22 are then positioned in such a way that each faces a wheel R of the vehicle V and is oriented in such a way that the optical measuring device 204 can see (frame) the wheel R.

Once the carriages 22 have been positioned, the emitters 300 are started (and, if necessary, also synchronized with each other) to emit the electromagnetic signals.

In this situation, the time interval between the instants the receiver 400 intercepts a first and a second electromagnetic signal deriving from at least one of the emitters 300 is measured for each receiver 400.

By measuring the time interval between the first and the second signal and since the mutual position between the sensors 402 of the same receiver 400 is known, the locating system is able to derive the position of each receiver 400, hence of each wheel R of the vehicle V inside the workspace.

While the receivers 400 are receiving the electromagnetic signals emitted by the emitters 300, the optical measuring devices 204 of each carriage 22 captures image data of a respective wheel R of the vehicle V so as to determine a position of the wheel R relative to the optical measuring device 204 facing it.

The signals representing the position of the receivers 400 derived by the locating system and the image data captured by the optical measuring device 204 are then sent to the processing unit.

In this situation, the location signals allow finding the positions of the wheels R in the workspace, while processing the image data allows obtaining the position of each wheel relative to the optical measuring device 204 facing the wheel R. By processing these position data with the stored data (that is, the data relating to the mutual position between the receiver 400 and the optical measuring device 204), the processing unit is able to place in mutual relation the data representing the positions of the wheels R. The processing unit is thus able to obtain the relative position (and, if necessary, the orientation) of each wheel R relative to the others, that is to say, it can obtain the overall alignment configuration of the vehicle V.

Unlike the prior art, by determining the real time position of each wheel R of the vehicle V through the exchange of signals between emitters 300 and receivers 400, and combining the location signals with each other through the image data, it is possible to obtain quick, easy and reliable information regarding the alignment of the vehicle V as a whole.

In an embodiment, measuring the alignment in real time is performed with the vehicle V stationary. In another embodiment, measuring the alignment in real time is performed with the vehicle V in motion.

In this situation, while the vehicle V is moving, the receivers 400 positioned in the workspace (on the vehicle V and/or on service structures 200 positioned in the workspace, as in FIG. 2) receive the signals emitted by the emitters 300 in order to perform the locating operations on the displaceable components 20. According to an aspect of this disclosure, the receivers 400 positioned on the moving vehicle V may be used to continuously detect the trend of the position of each component on which a receiver 400 is placed on board the vehicle V so that other diagnostic parameters can be obtained.

FIG. 3A shows a service apparatus 100 in which the service structure 200 is adapted for calibrating the sensors of an advanced driver assistance system (ADAS) of the vehicle V.

In this embodiment, the service structure 200 includes a carriage 23, 24 that is slidably movable on a supporting surface inside the workspace to be displaced relative to the vehicle V placed in the workspace.

The service structure 200 also comprises a calibration assistance structure 202 mounted on the carriage 23, 24 and including a calibration device 203, for example, a calibration target panel, configured to facilitate alignment or calibration of a sensor of an advanced driver assistance system (ADAS) of the vehicle V.

To calibrate front ADAS sensors of the vehicle V, the calibration device 203 comprises a calibration panel mounted on the calibration assistance structure 202, at a position specified by the vehicle manufacturer (FIG. 3A, front of the vehicle).

Alternatively, to calibrate side or rear sensors of the vehicle V, the calibration device 203 comprises two calibration panels attached to two supporting rods extending away from the carriage 24. The supporting rods are movable towards and away from each other. The supporting rods are also movable up and down along a respective axis of extension. The calibration panels are each movably mountable on a respective supporting rod. In this situation, a user can adjust the position of the supporting rods on the carriage 24 and the position of the calibration panels on the supporting rods so that the supporting rods and the panels adopt a position specified by the manufacturer of the vehicle V (FIG. 3A, rear of the vehicle).

Whether calibrating front ADAS sensors or rear or side ADAS sensors, for calibration of the ADAS sensors to be carried out in the optimal and correct manner, the calibration device 203 must occupy a specific position relative to the vehicle V, defined as the optimum position by the manufacturer of the vehicle V whose ADAS sensors are to be calibrated.

In this situation, the displaceable component 20 of the service structure 200 is the carriage 23, 24 which is provided with at least one receiver 400 so as to be located in real time by the locating system and subsequently moved in the workspace to contribute to correctly position the calibration device 203 mounted on it.

Preferably, also mounted on each wheel R of the vehicle V, for example by means of a stirrup, is a detector 400 so that the position of each wheel R in the workspace can be determined.

Again with reference to FIG. 3A, four emitters 300 are positioned at a raised position in the workspace so that the signals they emit can be intercepted by the detectors 400.

In use, therefore, to determine the real time position of the carriage 23, 24 (whether relative to the calibration assistance structure 202 of the front sensors or relative to the calibration assistance structure 202 of the side or rear sensors), the emitters 300 are activated so that they emit a respective succession of signals. In this situation, each receiver 400 intercepts at different time instants the electromagnetic signals which are emitted by the emitters 300 and which are processed by the locating system to derive the position of each receiver 400. In this situation, the processing unit receives the locating signals representing the position of each carriage 23, 24 and of the wheels R inside the workspace and processes them in order to determine the position of each carriage 23, 24 relative to the wheels R.

Since the position that the calibration device 203 must adopt for calibration to be performed correctly is known and since the position of each carriage 23, 24 relative to the vehicle V is known, the processing unit is able to provide the user with instructions for guiding and driving the carriage 23, 24 (together with the assistance structure 202 and the calibration device 203) so that the calibration device 203 is placed at a position where the sensor of the vehicle V can detect it.

With reference to FIG. 3B, the same locating procedure as that performed for the carriage 23, 24 can also be performed to locate a calibration device 203 mounted on a trestle-like supporting element 25 and, in particular, a device for calibrating the radar sensors of the vehicle V.

The calibration device 203, such as, for example, a reflecting prism or a Doppler signal simulator, is mounted on the trestle-like supporting element 25 and, in the calibrating procedure, must be placed at a position specified by the manufacturer of the vehicle V, relative to the vehicle V itself. In this embodiment, therefore, a receiver 400 is mounted at a predetermined position relative to the calibration device 203.

Preferably, a receiver 400 is also mounted on the wheels R of the vehicle V or, alternatively, on another portion of the vehicle V (such as, for example, the rear logo of the vehicle V). In this situation, the locating procedure performed for the carriage 23, 24 is also performed for the calibration device 203 positioned on the trestle-like supporting element 25 so that the calibration device 203 is positioned, relative to the vehicle V, at a position predetermined by the manufacturer of the vehicle V and considered the optimal position for calibrating the radar sensors.

As shown in FIG. 3C, instead of mounting a receiver 400 directly on each wheel R (FIG. 3A), the position of each wheel R inside the workspace might be determined using one or more carriages 22 of the type shown in FIG. 2. In this situation, the apparatus 100 is able to simultaneously provide information regarding both the alignment of the vehicle V and the calibration of the ADAS sensors.

Also an object of this disclosure is a method for performing a service on a vehicle V provided with rubber tyred wheels R and positioned in a workspace.

The method comprises a step of preparing a service structure 200 positioned in the workspace and including at least one displaceable component 20 configured to be displaced relative to the vehicle V or to be removably connected to the vehicle V.

The method also comprises a step of preparing a real time locating system (RTLS).

The locating system comprises one or more receivers 400 configured to receive electromagnetic signals and a plurality of emitters 300, each disposed at a predetermined, fixed position in the workspace and configured to emit a succession of electromagnetic signals.

According to an aspect of this disclosure, each receiver 400 comprises a body 401 on which sensors 402, such as photosensors configured to receive the signals emitted by one or more of the emitters 300, are distributed at predetermined, mutually spaced positions.

In an embodiment illustrated in the accompanying drawings (FIG. 4B), each emitter 300 comprises at least one optic generator 301a, 301b configured to emit a planar light beam. In this embodiment, the optic generators 301a, 301b are each also rotatable about a respective axis of rotation X, Y so that the planar light beam defines a rotating receiving plane.

Alternatively, each emitter 300 might be made according to what is described in US20190079191A1.

The method also comprises a step of positioning the at least one displaceable component 20 in the workspace, spaced from the vehicle V or connected to the vehicle V and a step of connecting one or more receivers 400 to the at least one displaceable component 20.

According to an aspect of this disclosure, the method also comprises a step of temporally synchronizing the emitters 300.

More in detail, each emitter 300 comprises a timer that can be activated to synchronize the emitters 300 of the locating system.

In the embodiment illustrated, the timer is defined by an intermittent light source 302.

The method then comprises a step of deriving the position (and, if necessary, the orientation) of the at least one receiver 400 in real time through the locating system. The step of deriving the position of the at least one receiver in real time through the locating system is based on processing a time interval between at least a first and a second electromagnetic signal emitted by at least one of the emitters 300 so as to generate a location signal representing the position of the displaceable component 20.

In use, therefore, the emitters 300 emit electromagnetic signals which are intercepted by the receiver 400 at a given time instant. The receiver 400, and more specifically, its sensors 402, thus detects at different time instants a succession of signals deriving from the emitters 300. By sampling the detection times and since the mutual position of the sensors 402 on the receiver 400 is predetermined, the real time position of the displaceable component 20 (on which the receiver 400 is operatively mounted) can be obtained.

The method also comprises a step of generating service information for a user, through a processing unit and based on the location signal received from the locating system.

In a possible embodiment, the locating system comprises, for each receiver 400, a control unit configured to measure the time between the instants the signals are intercepted and to derive the position of the respective receiver 400. In this situation, the method also comprises, before the step of generating, a step of sending in which the control unit sends a location signal representing the position of the receiver 400 to the processing unit.

With reference to FIG. 1, in the step of preparing the service structure 200, the method comprises a sub-step of applying on each wheel R of the vehicle V a stirrup 21, constituting the displaceable component 20 and removably connected to a respective wheel R of the vehicle V in a predetermined spatial relationship with the wheel R itself.

In the sub-step of applying, each stirrup 21 is connected to a receiver 400 forming part of a plurality of receivers included in the locating system.

In this situation, once the emitters 300 and the receivers 400 have been activated, the receivers receive the signals emitted by one or more of the emitters 300 so that the locating system determines a real time position of the receivers 400, hence a position of the wheels R they are mounted on.

By so doing, in the step of generating, the processing unit derives from the location signals received from the locating system, the characteristic angles of the wheels R of the vehicle V, including, for example, toe and camber.

With reference to FIG. 2 now, in the step of preparing the service structure 200, a carriage 22 is provided which is movable slidably on a supporting surface inside the workspace to define a displaceable component 20. The carriage 22 comprises a measuring unit 600 on which a receiver 400 and an optical measuring device 204, configured to capture image data of a wheel R of the vehicle V, are positioned at a predetermined position relative to each other.

In the embodiment shown in FIG. 2, two carriages 22 are provided, each running along a respective side F1, F2 of the vehicle V.

The method also comprises a step of adjusting the relative position of each carriage 22 relative to the vehicle V so that the optical measuring device 204 can “see” a wheel R of the vehicle V. In this situation, the locating system derives the position of each receiver 400, whilst the optical measuring device 204 captures image data of the wheel R.

The method also comprises a step of processing with the processing unit the location signals received from the locating system and the image data captured by each optical measuring device 204 in order to derive characteristic alignment angles of the wheels R of the vehicle V.

In other words, once the wheels R of the vehicle V have been located by the locating system, these data are sent to the processing unit which, by combining them with the image data from the optical measuring devices 204 of the carriages 22, obtains information regarding the alignment of the vehicle V as a whole.

With reference to FIG. 3A, in the step of preparing the service structure 200, a carriage 23, 24 is provided which is movable slidably on a supporting surface inside the workspace to define a displaceable component 20 provided with at least one receiver 400.

Preferably, the carriage 23, 24 is provided with a pair of detectors 400 opposite to each other relative to a vertical axis of the carriage 23, 24.

Also provided in this embodiment is an assistance structure 202 for the calibration of the vehicle V, mounted on the carriage 23, 24, and including a calibration device 203, configured to facilitate alignment or calibration of a sensor of an advanced driver assistance system (ADAS) of the vehicle.

It should be remembered that when calibrating the ADAS sensors, it is important for the calibration device 203 to occupy a predetermined position on the calibration assistance structure 202, as specified by the manufacturer of the vehicle V. It is also important for the calibration device 203 to occupy a predetermined position relative to the vehicle V, as specified by the manufacturer of the vehicle V.

The method thus comprises a step of positioning the calibration device 203 on the calibration assistance structure 202 in order to occupy the predetermined position specified by the manufacturer of the vehicle V.

FIG. 3A shows two carriages 23, 24: one carriage 23 for facilitating calibration of the front ADAS sensors and one carriage 24 for facilitating calibration of the rear and/or side ADAS sensors.

The method comprises a step of displacing each carriage 23, 24 relative to the vehicle V in such a way that the ADAS sensor to be calibrated can detect the calibration device 203.

According to an aspect of this disclosure, the method comprises a sub-step of applying on each wheel R of the vehicle V a stirrup 21, constituting a displaceable component 20 and removably connected to a respective wheel R of the vehicle V in a predetermined spatial relationship with the wheel R itself.

In the sub-step of applying, each stirrup 21 is connected to a receiver 400 forming part of a plurality of receivers included in the locating system.

Next, the locating system is activated and the position of the at least one receiver 400 placed on each carriage 23, 24 and the position of the receivers 400 placed on the wheels R are derived by processing the time interval between a first and a second signal emitted by at least one of the emitters 300.

The method also comprises a step of processing in real time the location signals deriving from the locating system in order to obtain positioning information regarding a position of the carriage 23, 24 relative to the vehicle V and, more specifically, relative to the wheels R thereof.

Preferably, this positioning information comprises instructions regarding the direction each carriage 23, 24 must be moved in to bring the calibration device 203 to the optimal position specified by the manufacturer of the vehicle V.

This invention achieves the preset aims and overcomes the disadvantages of the prior art.

More specifically, this invention allows a component of a vehicle service system to be located in real time precisely, quickly, reliably and at a limited cost.

The apparatus also allows preparing the systems and elements useful for checking the alignment of a vehicle and/or calibrating its sensors in a simple, reliable manner.

The method for performing a service is easy, precise and reliable.

1. A vehicle service apparatus, for a vehicle provided with rubber-tyred wheels and operatively positioned in a workspace of a repair shop, the apparatus comprising:
a service structure operatively positioned in the workspace and including at least one displaceable component configured to be displaced relative to the vehicle or to be removably connected to the vehicle;
a real-time locating system, or RTLS, including:
a plurality of emitters, each emitter being disposed at a predetermined, fixed position in the workspace and being configured to emit a succession of electromagnetic signals;
one or more receivers which are operatively connected to the at least one displaceable component and which are configured to receive electromagnetic signals emitted by the plurality of emitters,
the locating system being configured to derive a position of each receiver in real time based on processing a time interval between a first and a second electromagnetic signal sent to the receiver by at least one of the emitters;
a processing unit, connected to the locating system to receive a location signal representing the position of the displaceable component and programmed to generate service information for a user, based on the location signal.

2. The apparatus according to claim 1, wherein the receiver includes a body and a plurality of sensors associated with the body and distributed at predetermined positions, mutually spaced, the sensors being configured for receiving electromagnetic signals emitted by the emitters.

3. The apparatus according to claim 2, wherein each emitter of the plurality of emitters includes an optic generator configured to emit a planar light beam, each optic generator being rotatable about a respective axis of rotation so that the planar light beam defines a rotating receiving plane, wherein the receiver is intercepted and wherein the sensors are photosensors.

4. The apparatus according to claim 3, wherein the plurality of emitters includes at least a first and a second axis of rotation, inclined to each other, for a first and second optic generator, respectively.

5. The apparatus according to claim 1, wherein each emitter of the plurality of emitters includes an intermittent light source adapted to define a timer for the locating system.

6. The apparatus according to claim 1, wherein the plurality of emitters are located at an elevated position to overlook the workspace.

7. The apparatus according to claim 1, wherein the service structure includes at least one of the following displaceable components:
i) a carriage that is slidably movable on a supporting surface inside the workspace to be displaced relative to the vehicle which is positioned in the workspace;
ii) a stirrup 21 that is removably associable with a wheel of the vehicle in a predetermined spatial relationship with the wheel itself;
iii) a target to be used within an ASAS calibrating system;
iv) a feeler for sensing the centre of a wheel.

8. The apparatus according to claim 7, wherein the service structure includes a plurality of stirrups, each stirrup being operatively connected to a respective wheel of the vehicle in a predetermined spatial relationship with the wheel itself, and wherein the locating system includes a corresponding plurality of receivers, each receiver being connected to a respective stirrup of the plurality of stirrups.

9. The apparatus according to claim 8, wherein the processing unit is programmed to derive characteristic angles of the wheels of the vehicle from the location signals received from the locating system.

10. The apparatus according to claim 8, wherein the service structure includes:
a carriage that is slidably movable on a supporting surface inside the workspace to be displaced relative to the vehicle which is positioned in the workspace, one of the detectors being connected to the carriage;
an assistance structure for the calibration of the vehicle, mounted on the carriage, and including a calibration device, configured to facilitate alignment or calibration of a sensor of an advanced driver assistance system, or ADAS sensor, of the vehicle, the carriage being drivable in such a way that the sensor of the vehicle can detect the calibration device;
wherein the processing unit is programmed to process the location signals in real time to derive positioning information regarding a position of the carriage relative to the vehicle.

11. The apparatus according to claim 7, wherein the service structure includes:
a carriage that is slidably movable on a supporting surface inside the workspace to be displaced relative to the vehicle which is positioned in the workspace, one of the detectors being connected to the carriage;
an optical measuring device mounted on the carriage and configured for capturing image data of a wheel of the vehicle;
wherein the processing unit is programmed to derive characteristic angles of the wheels of the vehicle and/or toe and/or camber from the location signals received from the locating system and from the image data captured by the optical measuring device.

12. The apparatus according to claim 11, wherein the optical measuring device includes at least one of the following:
i) a pair of cameras in a stereo configuration;
ii) a laser imaging detection and ranging, or LIDAR, remote detector.

13. A method for performing a service on a vehicle provided with rubber tyred wheels positioned in a workspace, the method comprising the following steps:
preparing a service structure positioned in the workspace and including at least one displaceable component configured to be displaced relative to the vehicle or to be removably connected to the vehicle;
preparing a real time locating system, or RTLS, including one or more receivers configured to receive electromagnetic signals and a plurality of emitters, each emitter being disposed at a predetermined, fixed position in the workspace and emitting a succession of electromagnetic signals;
positioning the at least one displaceable component, spaced from the vehicle or connected to the vehicle;
connecting the one or more receivers to the at least one displaceable component;
deriving the position of the at least one receiver in real time through the locating system, based on processing a time interval between at least a first and a second electromagnetic signal emitted by at least one of the emitters so as to generate a location signal representing the position of the displaceable component;
generating service information for a user, through a processing unit and based on the location signal.

14. The method according to claim 13, wherein the receiver includes a body and a plurality of sensors associated with the body and distributed at predetermined positions, mutually spaced, and wherein the sensors receive electromagnetic signals emitted by the emitters.

15. The method according to claim 13, comprising a step of temporally synchronizing the emitters.

16. The method according to claim 13, wherein the service structure includes a plurality of stirrups, each constituting a displaceable component and being removably connected to a respective wheel of the vehicle in a predetermined spatial relationship with the wheel itself, wherein the locating system includes a corresponding plurality of receivers, each connected to a respective stirrup of the plurality of stirrups, and wherein the processing unit derives characteristic angles of the wheels of the vehicle from the location signals received from the locating system.

17. The method according to claim 13, wherein the service structure includes:
a carriage that is slidably movable on a supporting surface inside the workspace to define a displaceable component, one of the detectors being connected to the carriage;
an assistance structure for the calibration of the vehicle, mounted on the carriage, and including a calibration device, configured to facilitate alignment or calibration of a sensor of an advanced driver assistance system, or ADAS sensor, of the vehicle the method further comprising the following steps:
displacing each carriage relative to the vehicle in such a way that the sensor of the vehicle can detect the calibration device;
through the processing unit, processing the location signals in real time to derive positioning information regarding a position of the carriage relative to the vehicle.

18. The method according to claim 13, wherein the service structure includes:
a carriage that is slidably movable on a supporting surface inside the workspace to define a displaceable component, one of the detectors being connected to the carriage;
an optical measuring device mounted on the carriage and configured for capturing image data of a wheel of the vehicle;
the method further comprising the following steps:
adjusting the relative position of the carriage 22 relative to the vehicle so that the optical measuring device can “see” a wheel of the vehicle;
through the processing unit, processing the location signals received from the locating system and the image data captured by the optical measuring device in order to derive characteristic alignment angles of the wheels of the vehicle A.

19. A vehicle service apparatus, for a vehicle provided with rubber-tyred wheels and operatively positioned in a workspace of a repair shop, the apparatus comprising:
a service structure operatively positioned in the workspace and including a plurality of displaceable components, each displaceable component being displaced relative to the vehicle or removably connected to the vehicle;
a real-time locating system, RTLS, including:
a plurality of emitters, each emitter being disposed at a predetermined, fixed position in the workspace for emitting a succession of electromagnetic signals;
one or more receivers, connected to the displaceable components for receiving electromagnetic signals emitted by the plurality of emitters, the one or more receivers being synchronized with the emitters, so that a processor of the receiver, upon receiving a signal, correlates the signal to one of the emitters,
wherein the real-time locating system processes a time interval between a first and a second electromagnetic signal sent to the receiver by at least one of the emitters, and
derives in real time a position of each receiver based on said processing;
a processing unit, connected to the real-time locating system to receive a location signal representing the position of the displaceable component and programmed to generate service information for a user, based on the location signal.

20. The vehicle service apparatus of claim 19, wherein displaceable component of the plurality of displaceable components includes a feeler for sensing the centre of a wheel.
